(19) United States
(12) Patent Application Publication
(10) Pub. No.: US 2011/0249443 A1
(43) Pub. Date: Oct. 13, 2011

(54) LAMP COOLING SYSTEM

(75) Inventors: Pavel JURIK, Postredni Becva (CZ); Josef VALCHAR, Postredni Becva (CZ)

(73) Assignee: ROBE LIGHTING S.R.O.

(21) Appl. No.: 13/052,084

(22) Filed: Mar. 20, 2011

Related U.S. Application Data
(60) Provisional application No. 61/316,327, filed on Mar. 22, 2010.

(51) Int. Cl. F21V 29/00

(52) U.S. Cl. 362/294

(57) ABSTRACT

Disclosed is a luminaire designed for differential cooling of lamp light sources to create increase the cooling of temperature sensitive sections of a lamp using a shaped heat mirror 154 with aperture(s) 159 to direct airflow toward the temperature sensitive section(s) 33 of the lamp 30.

### RELATED APPLICATION

This application is a utility filing claiming priority of provisional application 61/316,327 filed on 22 Mar. 2010.

### TECHNICAL FIELD OF THE INVENTION

The present invention generally relates to an automated luminaire, specifically to a luminaire utilizing a high intensity discharge light source. More specifically to a system and method for cooling the light source.

### BACKGROUND OF THE INVENTION

Luminaires with automated and remotely controllable functionality are well known in the entertainment and architectural lighting markets. Such products are commonly used in theatres, television studios, concerts, theme parks, night clubs and other venues. A typical product will provide control over the pan and tilt functions of the luminaire allowing the operator to control the direction the luminaire is pointing and thus the position of the light beam on the stage or in the studio. This position control is often done via control of the luminaire's position in two orthogonal rotational axes usually referred to as pan and tilt. Many products provide control over other parameters such as the intensity, color, focus, beam size, beam shape and beam pattern. The beam pattern is often provided by a stencil or slide called a gobo which may be a steel, aluminum or etched glass pattern. The products manufactured by Robe Show Lighting such as the ColorSpot 700E are typical of the art.

FIG. 1 illustrates a typical multiparameter automated luminaire system 10. These systems commonly include a plurality of multiparameter automated luminaires 12 which typically each contain on-board a light source (not shown), light modulation devices, electric motors coupled to mechanical drives systems and control electronics (not shown). In addition to being connected to mains power either directly or through a power distribution system (not shown), each luminaire is connected in series or in parallel via data link 14 to one or more control desks 15. The automated luminaire system 10 is typically controlled by an operator through the control desk 15. Consequently, to affect this control both the control desk 15 and the individual luminaires typically include electronic circuitry as part of the electromechanical control system for controlling the automated lighting parameters.

FIG. 2 illustrates a prior art automated luminaire 12 utilizing a high intensity discharge (HID) lamp. An HID lamp 21 contains an arc or plasma light source 22 which emits light. The emitted light is reflected and controlled by reflector 20 through an aperture or imaging gate 24. The resultant light beam may be further constrained, shaped, colored and filtered by optical devices 26 which may include dichroic color filters, dimming shutters, and other optical devices well known in the art. The final output beam may be transmitted through output lenses 28 and 31 which may form a zoom lens system. Typically luminaires employing a HID type lamp employ a hot mirror 46 which is a window which transmits visible light and reflects non-visible energy radiating energy.

Such prior art automated luminaires use a variety of technologies as the light sources for the optical system. For example it is well known to use incandescent lamps, high intensity discharge (HID) lamps, plasma lamps and LEDs as light sources in such a luminaire. Many of these light sources, particularly the HID and plasma lamps, need cooling to maintain them within correct operating temperature limits. FIG. 3 illustrates one example of an HID lamp light source 30 and its major components. HID lamp 30 may comprise a sealed quartz envelope 37 with two contained electrodes 34 and 35 which are typically manufactured of tungsten. In operation an electrical arc is struck between electrodes 34 and 35 thus creating high temperature plasma and producing light. The specific mechanism and chemistry for the light production is beyond the scope of this patent and does not relate to the novelty of the invention. A critical area in the design of such lamps is the electrical connection from external power supplies to electrodes 34 and 35 which necessitates conveying the electrical power into the sealed quartz envelope 37 without compromising that seal. A common method utilized in the construction of such lamps is through thin foils 38 and 39, typically manufactured of molybdenum, attached to the electrodes 34 and 35. These thin foils 38 and 39 are squeezed between two opposing surfaces of the quartz envelope to provide a surrounding seal. These seal areas 32 and 33 are often referred to as the lamp ‘pinches’ as the quartz is pinched down onto the molybdenum foils to seal the lamp. The integrity of these seals or pinches is critical to the operation and longevity of the HID lamp as any leaks or breaks of the seal around the pinch may lead to premature failure of the lamp. An important factor in maintaining the integrity of the pinch areas 32 and 33 is controlling their temperature within closely defined parameters. The defined temperature ranges for the pinch areas 32 and 33 is often lower than that allowable for the remainder of the quartz envelope 37. For this reason, the pinch areas 32 and 33 can be considered heat sensitive sections of the lamp 30. In fact to ensure optimum performance of the chemical reactions taking place within the quartz envelope it may be desirable to maintain a temperature gradient along the lamp where the quartz envelope is at a first temperature while the pinches 32 and 33 are at a second, lower, temperature. Thus the luminaire designer must develop a cooling system which maintains this desired temperature gradient. A further constraint is the need for any cooling systems to avoid interfering with the reflector 31 or with any of the light beams emitted from the lamp or bounced from reflector 31.

FIG. 4 illustrates a prior art cooling system which seeks to maintain correct temperatures of the lamp 30 in particular the lamp envelope 37 and lamp pinches 32 and 33. In this design one or more fans 41 are directed into the reflector 31 in such a manner as to direct external cool air around the lamp 30. The cooling air may be directed directly on to the lamp as illustrated or may be directed at an angle so as to form a vortex of air around the lamp. A system like this, although somewhat effective, provides very little control of the desired temperature differentials between the lamp envelope 37 and pinches 32 and 33.

FIG. 5 illustrates a further prior art cooling system which seeks to maintain correct temperatures of the lamp 30 in particular the lamp envelope 37 and lamp pinches 32 and 33. In this design the lamp 30 and associated reflector are contained within a lamp house 45 which gives better control of airflow. In particular the area of the lamp house where the light from the lamp and reflector are emitted is typically manufactured as a transparent window 46 of high temperature glass. Window 46 may be manufactured with an applied thin film coating such that window 46 transmits visible light but reflects back long wavelength radiation such as infrared and heat. Such a coated window is often called a ‘hot mirror’ as it reflects heat. This hot mirror serves to reduce the heat content of the light beam and thus reduces heat in the optical devices within the luminaire. It also produces a lower temperature output beam which is more comfortable for performers illuminated with the luminaire. The use of a hot mirror for this purpose is well known in the art.

In the prior art design shown in FIG. 5 one or more fans 43 and 44 force cool air into the lamp house 45. Lamp house 45 is a sealed box with a single exit area 49 provided by an aperture on the rear of reflector 31 surrounding lamp 30. Thus air entering through fans 43 and 44 is constrained to flow up and around 47 the front lip of reflector 31, down past the lamp 30 and exits 48 via the rear aperture 49. Such a system may provide better cooling for the rear lamp pinch 32, as a large volume of cooler air must pass this pinch. However, the front pinch 33 is less well cooled. It is outside the main airflow 47 to 48 and only encounters slower moving turbulent airflow. Notwithstanding the issues this design offers significant improvements over that shown in FIG. 4 and gives some degree of desired temperature differentiation between lamp body 37 and pinches 32 and 33.

There is a need for a cooling system for a lamp in an automated luminaire which offers improved cooling of lamp pinches and controlled differential cooling between lamp pinches and lamp envelope.

### BRIEF DESCRIPTION OF THE DRAWINGS

For a more complete understanding of the present invention and the advantages thereof, reference is now made to the following description taken in conjunction with the accompanying drawings in which like reference numerals indicate like features and wherein:

FIG. 1 illustrates a typical automated lighting system;

FIG. 2 illustrates a prior art system;

FIG. 3 illustrates a typical light source in an automated luminaire;

FIG. 4 illustrates a prior art lamp cooling system;

FIG. 5 illustrates a prior art lamp cooling system;

FIG. 6 illustrates an embodiment of the invention;

FIG. 7 illustrates an alternative embodiment of the invention;

FIG. 8 illustrates a perspective view of an alternative embodiment of the invention;

FIG. 9 illustrates a further perspective view of an alternative embodiment of the invention;

### DETAILED DESCRIPTION OF THE INVENTION

Preferred embodiments of the present invention are illustrated in the FIGUREs, like numerals being used to refer to like and corresponding parts of the various drawings.

The present invention generally relates to an automated luminaire, specifically to a luminaire utilizing a high intensity discharge light source and the lamp cooling systems contained therein.

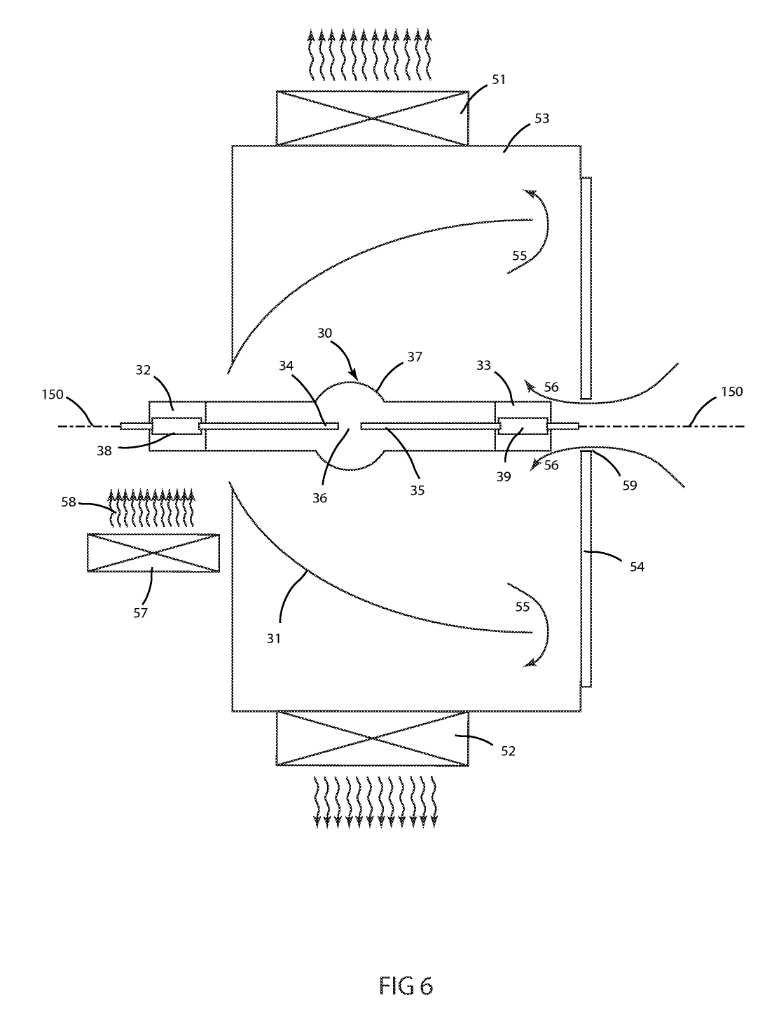

FIG. 6 illustrates an embodiment of the invention utilizing an HID light source 30 in an automated luminaire. HID lamp 30 may comprise a sealed quartz envelope 37 with two contained electrodes 34 and 35 which are typically manufactured of tungsten. In operation an electrical arc is struck between electrodes 34 and 35 thus creating high temperature plasma and producing light. The electrical connection from external power supplies to electrodes 34 and 35 is through thin foils 38 and 39, typically manufactured of molybdenum, attached to the electrodes 34 and 35. These thin foils 38 and 39 are squeezed between two opposing surfaces of the quartz envelope to provide a surrounding seal. These seal areas 32 and 33 are often referred to as the lamp ‘pinches’ as the quartz is pinched down onto the molybdenum foils to seal the lamp. HID lamp 30 may emit significant quantities of ultra violet (UV) and infrared (IR) energy as well as the desired visible light.

In FIG. 6 the lamp 30 and associated reflector 31 are contained within a lamp house 53. The area of the lamp house 53 where the light from the lamp and reflector is emitted to the optical systems of the luminaire may be manufactured as a transparent window 54 of a high temperature glass or quartz. Window 54 may further be manufactured with an applied thin film coating such that window 54 transmits visible light but reflects back long wavelength radiation such as infrared and heat. Such a coated window is often called a ‘hot mirror’ as it reflects heat. This hot mirror serves to reduce the heat content of the light beam and thus reduces heat in the optical devices within the luminaire. Window 54 contains a central aperture 59 which provides a path for air to enter or leave the lamp house. Although aperture 59 will allow some long wavelength or infra red radiation to exit the lamp house without passing through the optical coatings on window 54, aperture 59 is small compared to window 54 and thus the amount of long wavelength or infra red radiation exiting is minimal and not sufficient to be of any concern to optical devices in the luminaire.

In operation one or more fans 51 and 52 extract air from lamp house 53. Lamp house 53 is a partially sealed box with two air entrance areas provided by aperture 59 in window 54 and by a further aperture 60 on the rear of reflector 31 surrounding lamp 30. As air is extracted through fans 51 and 52 cool air 56 will be drawn into lamp house 53 primarily through aperture 59 and, to a lesser extent as it may be smaller and more constricted, aperture 60. Air 56 entering through aperture 59 will tend to impinge on the front pinch 33 of lamp 30. This air will then circulate around lamp 30 before exiting 55 around the lip of reflector 31 and through fans 51 and 52. Although two fans 51 and 52 are illustrated here the invention is not so limited and any number of fans may be utilized. By adjusting the relative sizes of apertures 59 and 60 the desired fine control of the cooling of pinches 32 and 33 compared to that of lamp envelope 37 may be achieved such that all lamp temperatures are optimized.

To further assist the cooling of rear pinch 32 a further fan 57 may impinge cooling air 58 directly onto the rear pinch area. In this case aperture 60 may be reduced in size or closed off entirely such that all air extracted by fans 51 and 52 will enter through aperture 59 to maximize cooling of the front pinch 33. In this manner independent temperature control of the two pinches may be further refined. For example, the rear pinch 32 fan 57 can provide additional cooling of the rear pinch to correct for temperature imbalance between the two pinches.

In alternative embodiments of the invention fans 51 and 52 may input air into the lamp house 53 instead of extracting it. In that case air will be reversed and will exit through apertures 59 and 60.

Although the figures shown here are of embodiments with imaging optics that are capable of producing projected images from gobo wheels and other pattern producing optical devices, the invention is not so limited and the light output from the optical system may be imaging where a focused or defocused image is projected, or non-imaging where a diffuse soft edged light beam is produced, without detracting from the spirit of the invention. The invention may be used as a lamp cooling system with optical systems commonly known as spot, wash, beam or other optical systems known in the art.

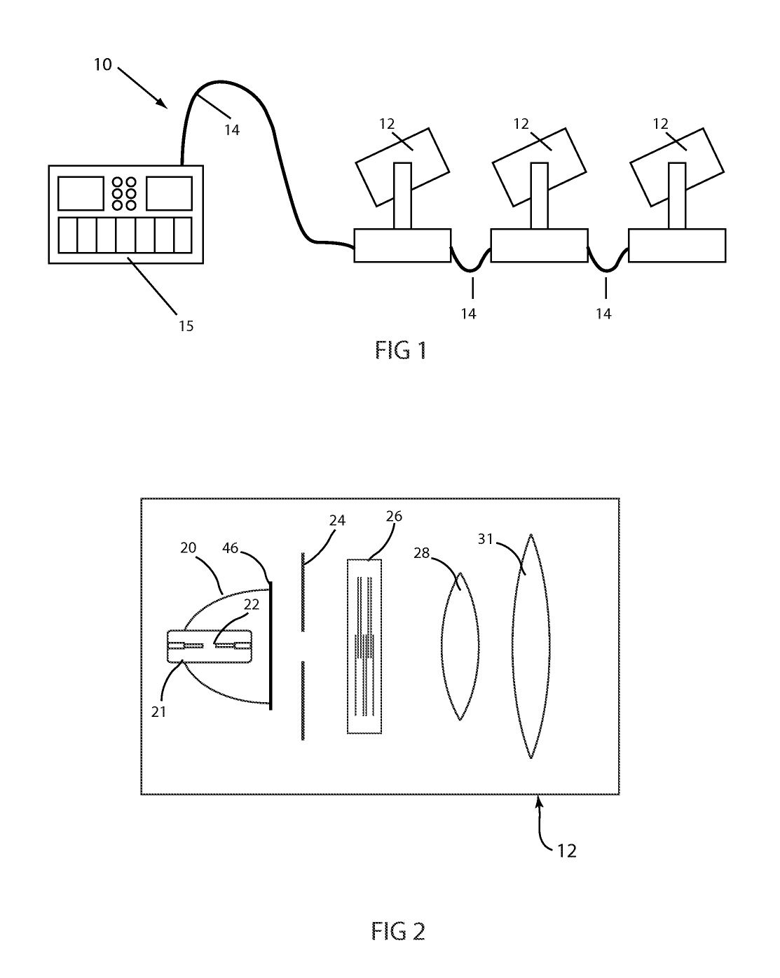

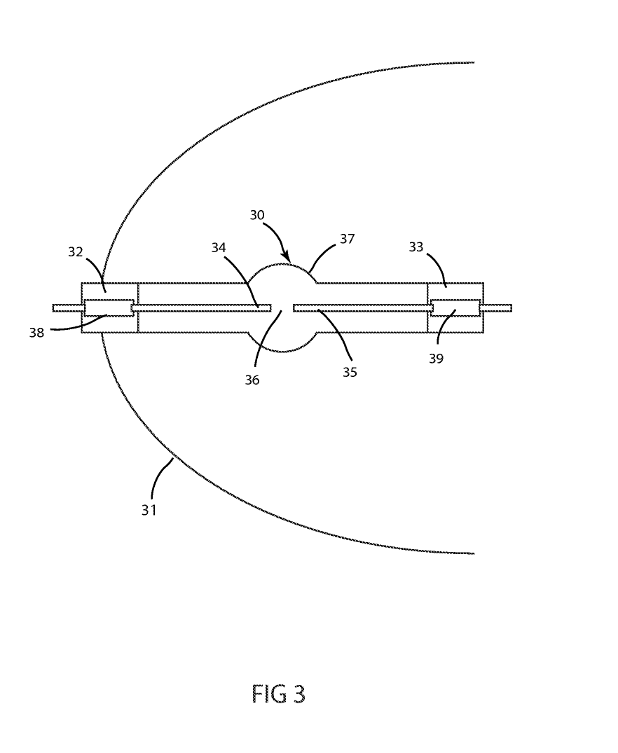

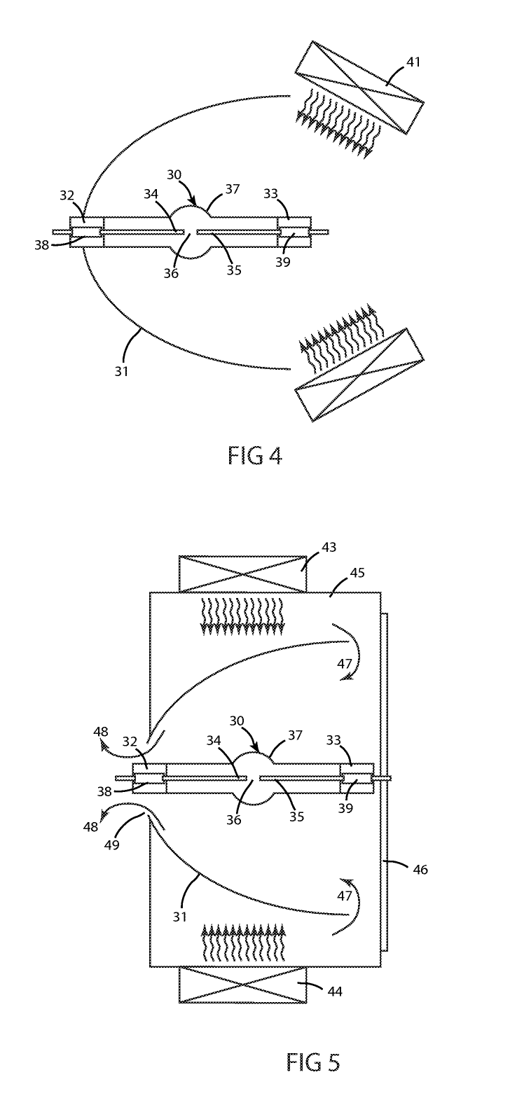

In yet further embodiments, the cooling system may be actively controlled using feedback from the lamp control system and temperature probes measuring the ambient temperature in and around the lamp and/or lamp house and controlling the speed of fans 51, 52 and 57 accordingly. Separate sensors may be used to sense temperatures at each lamp pinch and/or the central envelope and/or other locations inside and outside the luminaire house. Such systems may also use the power provided to lamp 30 to control the speed of cooling fans. For example, if the user commands the lamp to dim down to 20% output through the control console and link as shown in FIG. 1 then the cooling system may respond to this by reducing fan speeds to a level commensurate with the power level being provided to lamp 30. The commensurate level of fan speed is determined as a function of the heat power to heat generation curve of the source taken together with the cooling to fan speed curve(s) of for an internal external temperature differential. The fan speed may also be controlled based on the temperature input from the various sensors or the differential of temperatures across sensors.

In other embodiments the lamp cooling and fan speeds may be controlled through commands received over the communication link 14 shown in FIG. 1. Such commands may be transmitted over protocols including but not limited to industry standard protocols DMX512, RDM, ACN, Artnet, MIDI and/or Ethernet.

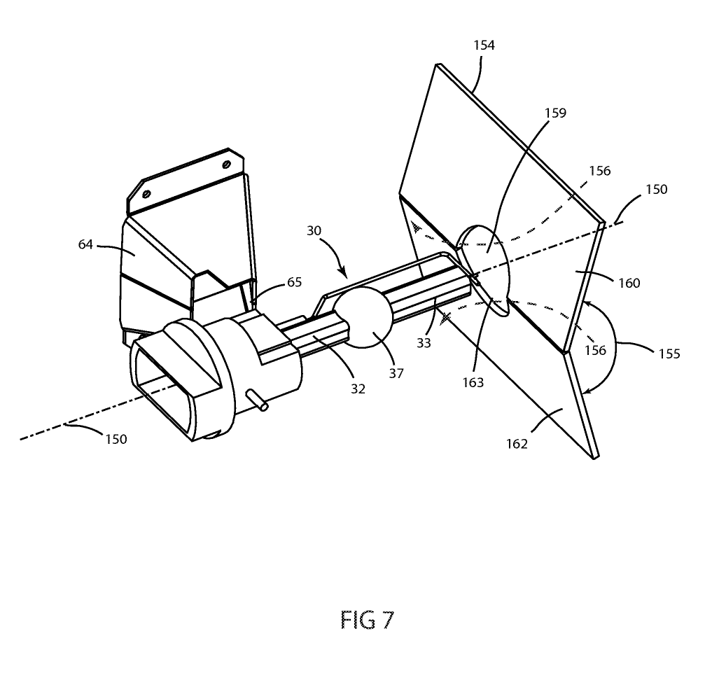

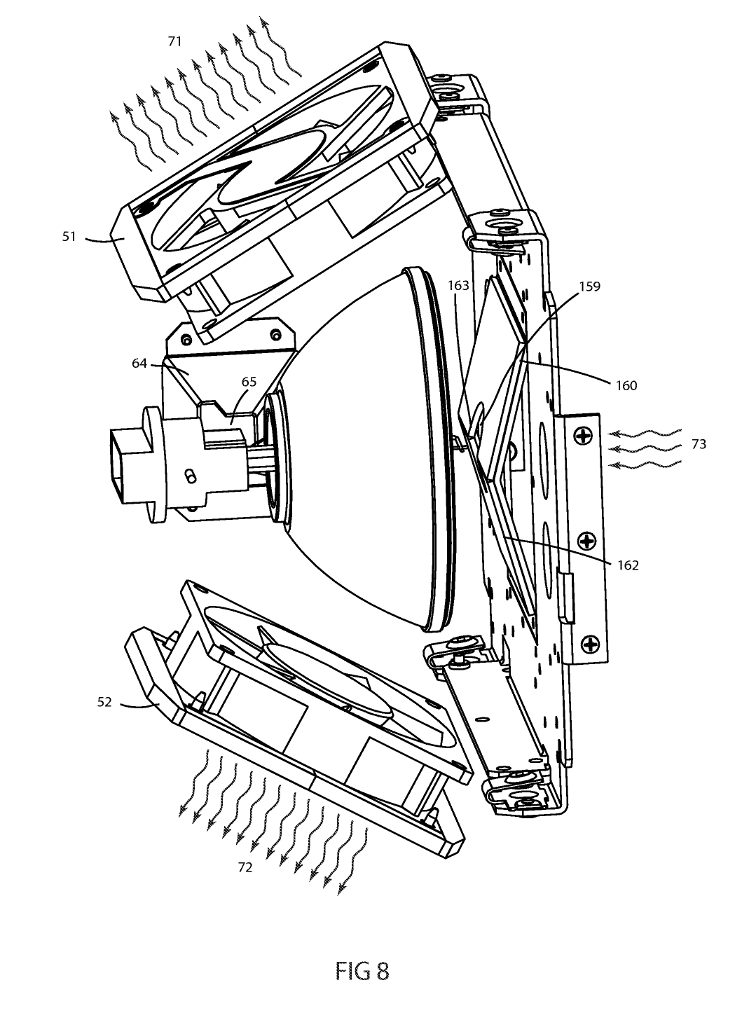

FIG. 7 illustrates an alternative embodiment of the invention as it may be used in an automated luminaire. Lamp 30 has pinches 32 and 33. In this embodiment the output window 154 which may have a hot mirror thin film coating is divided into segments 161 and 162 which are mounted at an angle to each other and to a plane normal to the optical axis of the luminaire. Notches 161 and 163 in the edges of segments 160 and 162 form an aperture 159. This angle 155 between segments 161 and 162 prevents multiple reflections between the surfaces of the window 154 and downstream optics. It further serves to direct reflected infrared and other long wavelength radiation away from lamp 30. The output window may be planar or constructed in any shape as well known in the art without detracting from the spirit of the invention. The output window may further be mounted at any angle relative to the output beam and optical axis. Rather than segments the window 154 can also be a single singe piece and my also have different shapes such as a conical shape. The shape and position of the aperture 163 along the optical axis 150 of the luminaire is optimized to regulate the airflow and therefore the cooling of the lamp pinches and the lamp envelope based on the airflow dynamics of the luminaires housing chambers. In the embodiments shown the output window 154 forms part of the boundary of a chamber of the luminaire's housing that holds the lamp and light source and the chamber of the housing that holds the rest of the optics such that air flow by the fans out of the lamp housing chamber causes air to flow through the window 154 aperture 159 into the lamp housing chamber from the chamber housing the other optics of the luminaire. This specific configuration is not necessarily the only housing or chamber configuration. However for the purposes of this cooling system it is preferable that the components be housed in a manner that airflow is encouraged to flow through the window aperture.

The system as illustrated in FIG. 7 is enclosed in a lamp house (not shown) with fans (not shown) to extract air as shown in FIG. 6. During operation these fans will pull air from the lamp house such that air 56 will be drawn into the system through aperture 63. This air 56 will impinge on lamp 30 in particular on the front pinch 33. Additionally air from a further fan (not shown) is directed through duct 64 to impinge on the rear pinch 32 of lamp 30. By these means lamp 30 and pinches 32 and 33 are optimally cooled.

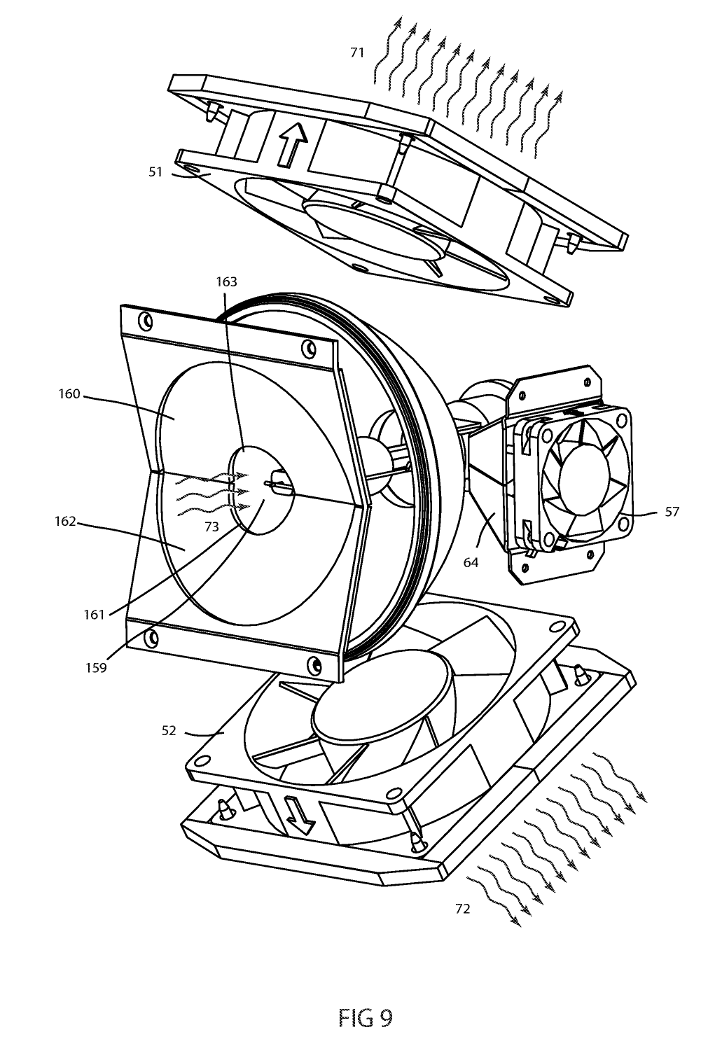

FIG. 8 illustrates a wider perspective view of the embodiment shown in FIG. 7. Fans 51 and 52 extract air 71 and 72 from a lamp house causing air 73 to be drawn into the lamp house through aperture 63 in an output window formed by two segments 61 and 62. Segments 61 and 62 may be manufactured with an applied thin film coating such that segments 61 and 62 transmit visible light but reflect back long wavelength radiation such as infrared and heat and act as a hot mirror. Air entering aperture 63 is directed towards the lamp and serves to cool it and its associated pinch as herein described. Additionally air is directed from a further fan (not shown) through exit aperture 65 of duct 64 onto the rear portion of the lamp and associated pinch.

FIG. 9 illustrates another perspective view of the exemplary embodiment of the invention shown in FIG. 7. Fans 51 and 52 extract air 71 and 72 from a lamp house causing air 73 to be drawn into the lamp house through aperture 63 in an output window formed by two segments 61 and 62. Segments 61 and 62 may be manufactured with an applied thin film coating such that segments 61 and 62 transmit visible light but reflect back long wavelength radiation such as infrared and heat and act as a hot mirror. Air entering aperture 63 is directed towards the lamp and serves to cool it and its associated pinch as herein described. Additionally air is directed from a further fan 57 through exit aperture 65 of duct 64 onto the rear portion of the lamp and associated pinch.

In further embodiments of the embodiments illustrated in FIG. 6 and FIG. 7 FIG. 8 and FIG. 9, employ a reflector that primarily reflects visible light and primarily passes or absorbs non-visible energy radiating both from the light source 30 and/or as reflected back by the hot mirror 54 and 154 respectively.

While the disclosure has been described with respect to a limited number of embodiments, those skilled in the art, having benefit of this disclosure, will appreciate that other embodiments may be devised which do not depart from the scope of the disclosure as disclosed herein. The disclosure has been described in detail, it should be understood that various changes, substitutions and alterations can be made hereto without departing from the spirit and scope of the disclosure.

What is claimed is:

1. A luminaire comprising:
a lamp which generates light and heat;
optical element(s) proximate to the lamp to collect and direct the light to form a light beam;
a window allowing transmission of the light beam; and
aperture(s) in the window positioned to allow air flow for cooling of the lamp.

2. The luminaire of claim 1 wherein:
the lamp has a temperature sensitive section(s) the cooling of which is desirable for longevity of the lamp; and
the window aperture is positioned to direct greater airflow proximate to the temperature sensitive sections of the lamp.

3. The luminaire of claim 2 wherein the lamp is an HID type lamp and the temperature sensitive sections of the lamp are the lamp pinches.

4. The luminaire of claim 1 where the airflows through the aperture(s) toward the lamp.

5. The luminaire of claim 1 where the airflows through the aperture away from the lamp.

6. The luminaire of claim 1 where the window is a hot mirror designed to reflect heat.

7. The luminaire of claim 6 where the hot mirror window is shaped to reflect the heat away from the lamp.

8. The luminaire of claim 7 where the hot mirror window shape is formed by a plurality of sections mounted at angles relative to the light beam and lamp.

9. The luminaire of claim 8 where the hot mirror sections are flat plates.

10. A luminaire comprising:
a lamp which generates light and heat with a plurality of heat sensitive sections;
optical element(s) proximate to the lamp to collect and direct the light to form a light beam;
a window allowing transmission of the light beam;
aperture(s) in the window positioned to direct air flow to focus cooling effects on at least one first heat sensitive section of the lamp; and
air flow diverters for directing air flow to focus cooling effects of airflow on at least one other second heat sensitive section of the lamp.

11. The luminaire of claim 10 wherein:
the relative air flow to the first and second heat sensitive sections of the lamp can be adjusted.

12. The luminaire of claim 10 where:
a first fan causes air flow through the window; and
a second fan causes air directed at the second heat sensitive section of the lamp.

13. The luminaire of claim 12 wherein the volume of air flow caused by the first and second fan are separately controllable.
